(19) United States
(12) Patent Application Publication
(10) Pub. No.: US 2009/0308960 A1
(43) Pub. Date: Dec. 17, 2009

(54) DEVICE FOR GRANULATING AND/OR MIXING

(75) Inventors: Rolf-Stefan Brickl, Warthausen (DE); Thomas Haegele, Mohringen (DE)

Correspondence Address: MICHAEL P. MORRIS;BOEHRINGER INGELHEIM USA CORPORATION, 900 RIDGEBURY RD, P. O. BOX 368, RIDGEFIELD, CT, 06877-0368, US

(73) Assignee: BOEHRINGER INGELHEIM INTERNATIONAL GMBH, Ingelheim (DE)

(21) Appl. No.: 12/376,075

(22) PCT Filed: Aug. 2, 2007
(86) PCT No.: PCT/EP07/58040

§ 371 Date: Mar. 31, 2009

(30) Foreign Application Priority Data
Aug. 5, 2006 (DE) 10 2006 036 682.4

(51) Int. Cl. B02C 17/16

(52) U.S. Cl. 241/98

(57) ABSTRACT

A device for granulating and/or mixing, in particular for a pharmaceutical active agent formulation, comprising a cylindrical granulation chamber (10) that can be closed with a lid (31). A rotating agitator (6) is arranged at the bottom of said granulation chamber (10), and a rotatable chopper (20) is arranged around the perimeter thereof. An insert (34) reducing the holding volume is attached to the lid (31).

The invention relates to a device for granulating and/or mixing, in particular, a pharmaceutical active substance formulation.

In the early stages of developing a formulation in the pharmaceutical industry there are often only small amounts of an active substance available for a multiplicity of formulation trials aimed at finding the optimum preparation. Another problem is presented by the processing or working of highly potent active substances, which has to be carried out in sealed housings, so-called isolators, to ensure adequate protection of personnel, while a standard commercial granulator is generally of such dimensions that it has to be housed in stationary manner in its own isolator.

From the art, a device for granulating and/or mixing is known which is manufactured and sold under the brand name MiPro by the company ProCepT nv, Zelzate, Belgium. Relatively small amounts of material can be processed with this device, in which an agitator head and a chopper project into a granulating chamber from above. According to information provided by the manufacturer, 40 g of material can be reproducibly granulated, which is often a very large amount at the early stages of the development of a formulation.

The problem of the invention is to provide a device of the type described which is suitable for processing substantially smaller amounts of material than the device known from the prior art.

According to the invention the problem is solved by a device for granulating and/or mixing, in particular, a pharmaceutical active substance formulation, having a cylindrical granulating chamber which can be closed off using a lid, this chamber being associated with a rotating agitator head at its base and a rotatable chopper around its circumference, while on the lid is attached an insert that reduces the capacity.

The insert that reduces the capacity of the granulating chamber makes it possible to granulate and/or mix tiny amounts of material. In addition, the device is easy to use as the material is placed in the ready-assembled device and then the lid with the insert is put on. The insert may be of such a height that its free end is located above the agitator head or chopper.

To ensure that the material that is to be processed drops down, the insert expediently tapers conically from its free end towards the lid. Thus the lid with the insert attached thereto can be put on without any problems where there is an agitator head or chopper installed inside the granulating chamber.

To avoid sharp edges inside the granulating chamber on which the material to be processed can accumulate, an inner wall of the insert preferably merges into an end wall running parallel to the lid, enclosing a radius.

According to a further feature, the insert and/or the lid can be fitted into the granulating chamber to form a seal.

The seal may be obtained for example using any desired sealing means, but preferably by maintaining relatively little play between the components that are to be joined.

The insert is expediently screwed to the lid. The insert can then be removed from the lid relatively easily for cleaning.

To ensure that the granulating chamber is mounted in a predetermined position, the granulating chamber preferably comprises at least one groove around its circumference into which a corresponding lug of a stationary chamber holder engages. The granulating chamber is preferably screwed to the chamber holder. This enables the granulating chamber to be removed quickly and easily. Alternatively, other connections that permit accurate fixing can be used, such as e.g. guide tubes with a liner, prisms or triclamp closures.

In order to ensure indirect action of a medium on the granulating chamber and the material contained therein, the granulating chamber is advantageously surrounded by a helically wound tube. According to one feature, the tube is connected via hoses to quick-release couplings for connection to a temperature control device. In this way a temperature needed for the granulation, particularly melt granulation, can be achieved by running a temperature-controlled fluid through the tube. The hoses and quick-release couplings ensure rapid and trouble-free connection of the helical tube to the temperature control device. Alternatively, a temperature-controlled heating foil or a temperature-controlled heating jacket is associated with the granulating chamber.

For intimately mixing the material in the granulating chamber, the agitator head expediently has three agitator blades aligned with one another in a star shape and is attached to a knurled head screw on a drive shaft. The knurled head screw enables the agitator head to be mounted or removed rapidly and without the need for tools.

In order to reduce the amount of granulate that adheres to the inner walls of the granulating chamber, the outer diameter of the agitator blades is slightly smaller than the inner diameter of the granulating chamber. As a result, the agitator blades pick up any material adhering to the inner walls for further processing.

For effective comminution of the material, the chopper preferably comprises a number of chopper blades which are adapted to fit the insert in order to scrape off any granulate.

To minimise the loss of material caused by adhesion to the device, the surfaces that come into contact with the material that is to be granulated or mixed are advantageously provided with a nano-coating.

The device according to the invention, suitably dimensioned, can be used to process very small batch quantities, while the geometry and arrangement of the granulating chamber, the chopper and the agitator head can be chosen to suit a device designed for mass production, thus enabling so-called upscaling to be carried out without any difficulty.

It will be understood that the features mentioned above and those to be described hereinafter may be used not only in the particular combination specified but also in other combinations. The scope of the invention is defined only by the claims.

The invention is hereinafter described in more detail by means of an exemplifying embodiment, with reference to the associated drawings, wherein:

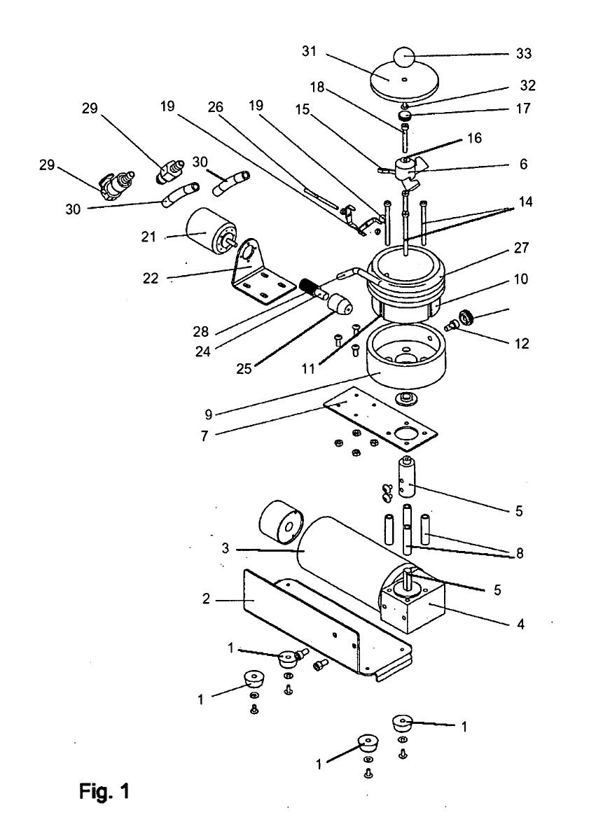

FIG. 1 is an exploded view of a device according to the invention,

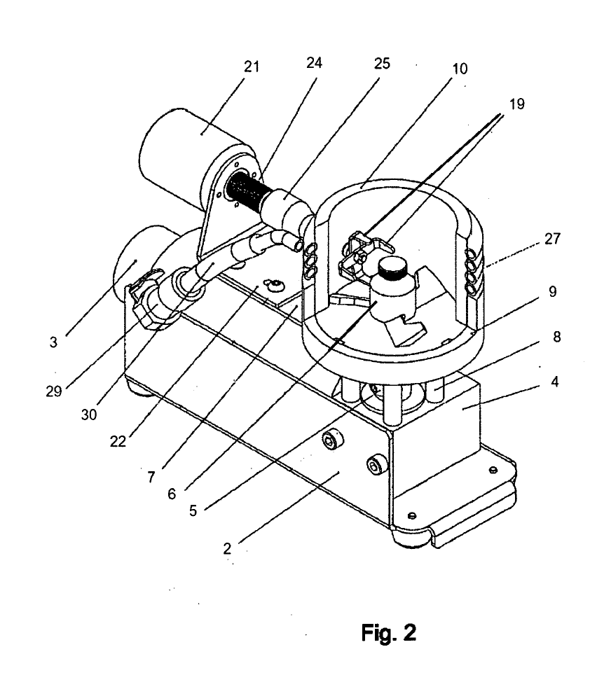

FIG. 2 is a perspective view of the device according to FIG. 1 in partial section and

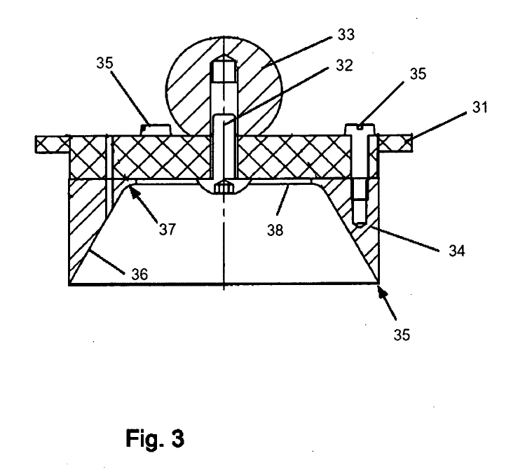

FIG. 3 is an enlarged sectional view of a lid with an insert for the device.

The device comprises a basic frame 2 mounted on rubber feet 1, on which is secured an a.c. or d.c. motor 3 with a cascade gearbox 4. The cascade gearbox 4 is coupled to a drive shaft 5 for an agitator head 6. In addition, a holding plate 7 is fixed on the basic frame 1 via interposed spacer sleeves 8, the holding plate 7 serving to attach a chamber holder 9 for a granulating chamber 10. For securing the granulating chamber 10 in position relative to the chamber holder 9 the granulating chamber 10 comprises, on its outer circumference, grooves 11 in which corresponding lugs of the chamber holder 9 engage. The fixing of the granulating chamber 10 to the chamber holder 9 is carried out using a transverse screw 12 with a knurled screw head 13 for assembly without the need for tools and using screws 14 protruding through a base of the granulating chamber 10. The agitator head 6 comprising three agitator blades 15 aligned with one another in a star shape has a concentric bore 16 for a screw 18 provided with a knurled screw head 17 for attachment to the drive shaft 5.

For comminuting or granulating material, a chopper 20 is provided comprising four chopper blades 19 in a cross-shaped arrangement, which projects circumferentially, i.e. laterally, into the granulating chamber 10 and is driven by a horizontally mounted motor 21. The motor 21 is connected to the holding plate 7 via a motor mount 22. A drill chuck 25 for receiving the shaft 26 that mounts the chopper blades 19 is fixed to a motor shaft 23 via a drill chuck holder 24.

A helically bent tube 27 is passed over the outer periphery of the granulating chamber 10, its ends 28 each being connected to a hose 30 comprising a quick-release coupling 29. The tube 27 can be connected to a temperature control device via the quick-release couplings 29 in order to achieve a desired constant temperature of the granulating chamber 10, which is particularly important during melt granulation.

The granulating chamber 10 is sealed off at the top by a lid 31 forming a seal thereon, which carries a spherical knob 33 attached by a screw 32. Attached to the underside of the lid 31 by means of screws 35 is an insert 34 that reduces the capacity of the granulating chamber 10. The insert 34 tapers conically from its free end 35 towards the lid 31, while an inner wall 36 of the insert 34 merges into an end wall 38 extending parallel to the lid, enclosing a radius 37. The outer circumference of the insert 34 is of suitable dimensions for engaging in the granulating chamber 10 in sealed manner.

The device has a total length of about 215 mm, a total width of about 105 mm and a total height of about 185 mm, for example, and is suitable in particular for processing weights of material ranging from about 5 to 10 g.

In spite of the very compact dimensions of the device all the essential characteristics of granulation can be accurately determined:
speeds of rotation of the agitator and chopper motor by means of the number of volts selected in the case of d.c. motors and/or by means of contactless revolution counters
temperature of the granulated material by means of temperature sensors inserted from above or from the side
viscosity of the granulation mass by measuring the torque on the drive shaft of the agitator motor or by means of the current consumption of the agitator motor.

These measurement data make it easy to upscale the granulation process.

### LIST OF REFERENCE NUMERALS

1. rubber foot
2. basic frame
3. d.c. or a.c. motor
4. cascade gearbox
5. drive shaft
6. agitator head
7. holding plate
8. spacer sleeve
9. chamber holder
10. granulating chamber
11. groove
12. transverse screw
13. knurled screw head
14. screw
15. agitator blade
16. bore
17. knurled screw head
18. screw
19. chopper blade
20. chopper
21. motor
22. motor mount
23. motor shaft
24. drill chuck holder
25. drill chuck
26. shaft
27. tube
28. end of 28
29. quick-release coupling
30. hose
31. lid
32. screw
33. spherical knob
34. insert
35. end
36. inner wall
37. radius
38. end wall

1. Device for granulating and/or mixing, in particular, a pharmaceutical active substance formulation, having a cylindrical granulating chamber (10) that can be closed off by a lid (31), which is associated at its base end with a rotating agitator head (6) and around its circumference with a rotatable chopper (20), while attached to the lid (31) is an insert (34) which reduces the holding capacity.

2. Device according to claim 1, characterised in that the insert (34) tapers conically from its free end (35) in the direction of the lid (31).

3. Device according to claim 1, characterised in that an inner wall (36) of the insert (34) merges into an end wall (38) extending parallel to the lid (31), enclosing a radius (37).

4. Device according to claim 1, characterised in that the insert (34) and/or the lid (31) can be inserted in the granulating chamber (10) in sealed manner.

5. Device according to claim 1, characterised in that the insert (34) is screwed to the lid (31).

6. Device according to claim 1, characterised in that the granulating chamber (10) comprises at least one circumferential groove (11), into which a corresponding lug of a stationary chamber holder (9) engages.

7. Device according to claim 1, characterised in that the granulating chamber (10) is screwed to the chamber holder (9).

8. Device according to claim 1, characterised in that the granulating chamber (10) has a tube (27) winding helically round it.

9. Device according to claim 8, characterised in that the tube (27) is connected via hoses (30) to quick-release couplings (29) for attachment to a temperature control device.

10. Device according to claim 1, characterised in that associated with the granulating chamber (10) is a temperature-controlled heating foil or a temperature-controlled heating strip.

11. Device according to claim 1, characterised in that the agitator head (6) comprises three agitator blades (15) aligned with one another in a star shape and is attached by a knurled head screw to a drive shaft (5).

12. Device according to claim 11, characterised in that the outer diameter of the agitator blades (15) is slightly smaller than the inner diameter of the granulating chamber (10).

13. Device according to claim 1, characterised in that the chopper (20) comprises a plurality of chopper blades (19) which are adapted to fit the insert (34) in order to scrape off granulate.

14. Device according to claim 1, characterised in that the surfaces that come into contact with the material to be granulated or mixed are provided with a nano-coating.
